(19) United States
(12) Patent Application Publication
(10) Pub. No.: US 2024/0102330 A1
(43) Pub. Date: Mar. 28, 2024

(54) SAFETY DEVICE FOR AUTOMATED DOOR SYSTEMS, DOOR SYSTEM EQUIPPED THEREWITH AND OPERATING METHOD FOR SUCH A DOOR SYSTEM

(71) Applicant: dormakaba Deutschland GmbH, Ennepetal (DE)

(72) Inventor: Frank Wegner, Ennepetal (DE)

(21) Appl. No.: 18/446,974

(22) Filed: Aug. 9, 2023

(30) Foreign Application Priority Data
Aug. 12, 2022 (EP) 22190293.5

(51) Int. Cl. E05F 15/42; E05F 15/608

(52) U.S. Cl. CPC E05F 15/42; E05F 15/608; E05F 2015/487

(57) ABSTRACT

A safety device of an automated door system has a sensor device for arrangement on the door system such that a detection region of the sensor device covers a danger region of a door leaf using sensors. The sensor device detects the presence of an object within the detection region and has a control device for changinge the detection region on the basis of a current movement speed of the door leaf and/or to actuate the drive of the door leaf in the event of a safety response such that a braking distance of the door leaf is adapted to the current movement speed of the door leaf. The use of the safety device in a door drive with a drive unit for moving, or in a door system with, the associated door leaf an automated door system, and an operating method for the door system are also related.

### CROSS-REFERENCE TO RELATED APPLICATIONS

This application claims the benefit of European patent application 22190293.5, filed on 12 Aug. 2022, the disclosure of which is incorporated herein by reference in its entirety.

### TECHNICAL FIELD

The disclosure relates to a safety device of an automated door system and an automated door system equipped therewith. In addition, the disclosure relates to the use of such a safety device in a door drive with at least one drive unit for moving the at least one associated door leaf or in a door system. Furthermore, the disclosure relates to a method for operating such a door system.

### BACKGROUND

Generic automated door systems comprise at least one door leaf, which is moved by means of a drive. In the case of a revolving door, at least its turnstile (with door leaves attached thereto in a fixed or pivoting manner) is rotated in a predefined direction of rotation. If the door leaves are pivotably attached, they can also be pivoted by means of a respective drive. In the case of sliding and swing doors, their door leaf(s) is or are moved automatically, i.e. by means of an associated drive, both in the opening and in the closing direction. The door leaves thereby cover an associated movement region.

In the case of a revolving door, this is a circular area. In the case of sliding doors, this is the path along which the respective sliding door leaf is moved. In the case of a swing leaf of a revolving door or swing door, this is the partial circular area region within which the respective swing leaf is moved. For all door systems, the region always seen in the movement direction of the respective door leaf is meant. Objects such as people, animals and items can thereby be located in the movement path of a door leaf or move into the movement path or towards the door leaf or away from the door leaf more slowly than the door leaf itself moves. This creates danger regions, which are usually protected by non-contact sensors. The sensors have a defined detection field that includes the danger regions. If an object is identified or detected within the detection field, the sensor sends a signal to the associated door drive and a safety response occurs in that the current door leaf movement is braked, stopped or reversed by means of the drive.

As is well known, there is always only one possible response for each danger zone. The movement speed of the associated door leaf realized by the respective door drive is set manually when the door system is commissioned such that this door leaf can be stopped in good time in the event of danger. It must be noted here that the faster and heavier the associated door leaf(s) is or are, the longer the braking distance is. The controller of the door drive does not know the position and size of the detection field and therefore cannot automatically limit the travel speed. The braking force for the door leaves of a door system is set uniformly, it is fixed for a specific door leaf movement speed/mass combination. In practice, the detection field of the safety sensors is manually compared with the required braking distance. The position of the detection field is set mechanically (manually) by pivoting the sensor device and is therefore only valid for one speed. If the travel or movement speed of the respective door leaf decreases, this can lead to an object being detected too early and the door no longer opening correctly. If the travel speed increases, the object may be detected too late and the door leaf will hit the object, resulting in a significant risk of injury. Such a change in travel speed can occur, in particular in the case of revolving and swing doors, due to wind or manual actuation, and safeguarding of the danger regions is not always assured. With sliding doors, the wind load can also lead to a reduction in travel speed. The travel speed set during installation is not changed during operation. In any case, the coordination with the respective sensor detection region is no longer correct. If an object in the form of a person or an animal approaches the respective door system or one of its danger regions at too high or too low a speed, this can have effects similar to changing the travel speed.

EP 3 026 457 A1 discloses a device for monitoring a detection field, in which a sensor detection field is monitored. However, a deviation of an actual from a target detection field only leads to a safety response, for example in the form of a warning signal, the detection field remains unaffected.

### SUMMARY

The present disclosure overcomes the aforementioned disadvantages. In particular, the disclosure further develops a generic safety device or door system equipped therewith and to operate the door system such that it offers greater ease of entry with the same or even improved safety.

This is achieved proceeding from a safety device according to the preamble of claim 1, an automated door system according to the preamble of claim 6 and an operating method for such a door system according to the preamble of claim 11 in conjunction with the respectively characterizing features. Advantageous further developments of the disclosure are indicated in the dependent claims. Also according to the disclosure is the use of a safety device in a door drive or in a door system.

The disclosure includes the technical teaching that a safety device of an automated door system has a sensor device. The sensor device with one or a plurality of sensors is designed to be arranged on the door system such that its associated detection region covers a danger region of an associated door leaf using sensors. This is, for example, the main closing edge of a door leaf of the door system. In addition, the sensor device is configured to detect the presence of an object within the associated detection region. Apart from that, the safety device has a control device. According to the disclosure, the control device is configured to change the associated detection region on the basis of a current movement speed of the associated door leaf. In order to be able to ensure that the door leaf can be braked safely without colliding with any object, the detection region in relation to the edge or the side that points in the movement direction of this door leaf is changed, for example, such that its maximum distance from the door leaf increases the higher the door leaf movement speed. Alternatively or additionally, it can be provided according to the disclosure that the control device is configured to determine a detection geometry and to actuate a door drive of the associated door leaf such that a predetermined, i.e. a maximum permissible and/or possible, movement speed of the associated door leaf is provided depending on the determined detection geometry. Alternatively or additionally, the door drive is actuated such that a braking force and/or a braking distance of the associated door leaf is or are adapted to the current movement speed of the associated door leaf. In the event of a safety response (i.e. if an object has been detected in the movement path of the door leaf), it should be possible to actuate the drive of the associated door leaf such that it is adapted to its current movement speed of the associated door leaf. That is to say that the faster the door leaf moves, for example due to a wind load, the more it is braked in order to avoid a collision with the detected object. In both cases, the safety of the door system is guaranteed. As a result, either the detection region is adapted to the door leaf movement speed by the disclosure or the detection region preferably remains the same, and the detection geometry and thus the detection distance in relation to the associated door leaf or the door system as a whole are calculated such that the control device can find out how fast the door leaf may be moved at all. In addition, the control device has knowledge of how strongly the door leaf must be braked when an object appears in the detection region so that this door leaf can still stop safely in front of the object or only hits it with a defined force or final speed that is classified as non-hazardous for the object. This has the additional advantage that the usual manual calculation and setting (input) of the maximum permissible door leaf movement speed during installation or maintenance of the door system can be omitted. This increases operational safety and reduces the susceptibility to errors. This is possible in particular because there is a data connection, wired and/or wireless, between the control device and the sensor device, or the sensor device or its sensors is or are an integral part of the control device. The control device can thus interact with the sensor device. The sensor device can thereby have infrared and/or radar sensors, in particular consist of a radar sensor unit.

It is also conceivable that the door leaf movement speed or travel speed is dynamically adapted depending on the approach speed of an object. The consequence of this is that people moving faster are no longer slowed down as much or at all by the door system, which improves the ease of entry of the door system.

Said detection region of the sensor device can be changed in that the sensor device has an adjustment device which is coupled to the control device such that the control device is able to adjust the sensor device. The adjustment is thereby made such that the detection region changes. In the case of a pivotally mounted sensor device, its setting angle can be changed in a motorized manner. Alternatively or cumulatively, it is conceivable that the sensor device has a plurality of sensors. In this way, the detection region can be additionally or alternatively changed in that, depending on the movement speed of the associated door leaf, an associated number of sensors is or remains activated and other sensors are deactivated. The deactivation can take place by switching off or also shielding the other sensors, i.e. not mechanically but electrically or by programming or physically. All these measures are easy to implement and do not cost much.

The detection geometry is preferably determined by means of a height and an angle of the sensor device in relation to a floor or a door sill or comprises these values. The height is therefore preferably the mounting height of the sensor device. The angle is preferably the detection angle of the sensor device. As a result, it is very easily and, in particular when the door system is in operation, quickly, that is to say highly dynamically, possible to adapt the movement characteristics of the associated door leaf.

Each of the mentioned control devices can be configured to determine the detection geometry such that the braking force and/or the braking distance of the associated door leaf is or are adapted to the current movement speed of the associated door leaf in the event of a safety response. This makes it possible, for example, to stop the door leaf safely as a safety response even at increased movement speed if an object is detected in the detection region. In this way, a collision is also avoided in this case, or ideally the risk of a collision is reduced to a level that would also be the case with a lower movement speed of the door leaf.

The disclosure also provides for the use of one of the mentioned safety devices in a door drive with at least one drive unit for moving the at least one associated door leaf or in a door system with the at least one associated door leaf. This means that the security device can be used universally in practically any type of automated door system.

The disclosure also provides an automated door system. According to the generic type, the door system has at least one door leaf and, for the at least one door leaf, a door drive which is movement-operatively connected to the at least one door leaf. According to the disclosure, one of the aforementioned safety devices is provided. The at least one door leaf is the associated door leaf specified in relation to the respective safety device.

A door leaf is preferably designed as a sliding door leaf. The door system can therefore be a sliding door or a revolving door with automatic night shutter. The danger region of the sliding door leaf during its closing movement comprises a region of its travel path, seen in the closing direction, directly in front of its main closing edge. During the opening movement of the sliding door leaf, the danger region can also comprise a region of its travel path, seen in the movement direction, directly in front of its secondary closing edge of the sliding door leaf, a region laterally, i.e. pointing in a respective direction of entry, adjoining the sliding door leaf. Overall, the entire region around the sliding door leaf can be defined as a danger region.

Alternatively or additionally, a door leaf can be designed as a swing door leaf. Its danger region is a predetermined part of a region which the swing door leaf covers during its opening and closing movement and which is located in front of the swing door leaf in the movement direction of the swing door leaf. That is to say that the disclosure can also be used with such door systems.

The door system is preferably designed as a revolving door with a turnstile. A door leaf is attached to the turnstile, and the danger region of the door leaf is a predetermined part of a circular area which the door leaf covers due to the rotation of the turnstile and is located in front of the door leaf in the direction of rotation of the turnstile.

The disclosure also provides a method for operating one of the aforementioned door systems. The method comprises monitoring the danger region of the associated door leaf by means of the sensor device of the safety device of the door system. As part of the method, the detection region of the associated door leaf is adapted or changed on the basis of a current movement speed of the associated door leaf. Alternatively or additionally, a detection geometry can be determined and a door drive of the associated door leaf can be actuated such that a predetermined movement speed of the associated door leaf is provided depending on the determined detection geometry. Provision can also be made for a braking force and/or a braking distance of the associated door leaf to be adapted to the current movement speed of the associated door leaf. In this way, the operation of the door system can be dynamically adapted to the detection region and the current operating conditions such as wind loads without compromising safety.

In the event of a safety response, provision can be made for the detection region of the associated door leaf to be adapted such that it is ensured that the associated door leaf reaches the maximum position of a possible object in the detection region of the sensor device when it is first detected and/or taking into account its relative speed to the door leaf, or, in its current movement direction, comes to a standstill in front of this position. That is to say that the faster this door leaf moves, the larger the detection region can be set in the movement direction of the door leaf. This makes it possible to always stop the door leaf safely in front of any detected object while the braking force of the associated drive remains the same, such that a collision is avoided. Alternatively or additionally, in the event of a safety response, i.e. if an object has been detected, the method can provide for the drive of the associated door leaf to be actuated such that it is again ensured that the associated door leaf reaches the maximum position of a possible object in the detection region of the sensor device when it is first detected or, in its current movement direction, comes to a standstill in front of this position. This can be effected, for example, by increasing the braking force by way of the drive or an electromechanical brake, for example. All of this has the advantage of being able to operate the associated door leaf faster, or at least adapted to the operating conditions, with the same or even increased safety of the door system. External accelerations of the associated door leaf can also be compensated for, for example, due to a wind load.

In the method according to the disclosure, the safety response preferably comprises stopping the associated door leaf, in particular if the recorded relative speed between the detected object and the associated door leaf corresponds to the movement speed of the associated door leaf at the time the respective object is first detected. Within the scope of the disclosure, the relative speed is greater the faster the door leaf and the detected object approach one another. If the (average) distance between the door leaf and the detected object remains the same, the relative speed is 0. If the distance increases instead, i.e. if the object moves away from the door leaf, the relative speed is less than 0, i.e. negative. Stopping can also be provided if an object is also detected on a side of the associated door leaf facing away from the detected object, in particular if the relative speed between this object and the door leaf is less than the movement speed of the door leaf. In this case, the object moves in the direction of the door leaf. This scenario serves the purpose of keeping the risk of injury or damage to the object(s) as low as possible. The safety response can also comprise a reversing of the associated door leaf. This can be provided in particular if the recorded relative speed between the detected object and the associated door leaf is higher than the movement speed of the associated door leaf at the time the respective object is first detected and no object is detected on the side of the associated door leaf facing away from the detected object. That is to say that the object detected in front of it in the movement direction of the door leaf moves towards the door leaf. This is intended to cause the door leaf to ideally move away from the object without colliding with the object. The method can also provide for merely slowing down the associated door leaf, in particular if the recorded relative speed between the detected object and the associated door leaf is greater than 0 and at the same time lower than the movement speed of the associated door leaf at the time the respective object is first detected. That is to say that the object is just slower than the door leaf. This effectively avoids a collision. The slowing down can also be provided if an object is also detected on the side of the associated door leaf facing away from the detected object. This reliably avoids any collision with the latter object, in particular if it moves in the direction of the door leaf, i.e. in the passage direction through the door system.

In normal operation, the respective drive can be actuated in the above- mentioned methods depending on a sensor-determined entry speed in relation to the associated door leaf. The entry speed can thereby correspond to the maximum of the determined relative speeds. This increases safety in the case of a plurality of detected objects or objects.

In each of the methods mentioned, the entry speed can correspond to the movement speed of the object moving fastest towards the passage region of the door system or through the passage region or of the object with the greatest relative speed to the respective door leaf. “Fastest” does not necessarily mean the movement speed of the object. Rather, the current distance to the door leaf and its own movement speed are also thereby taken into account. That is to say that a slower moving object that is located closer to the door leaf could be more likely to constitute the entry speed than a more distant, faster object. This serves to dynamically adapt the movement speed of the relevant door leaf with regard to ease of entry and to reduce the risk of collision between the door leaf and the object.

### BRIEF DESCRIPTION OF THE DRAWINGS

Further measures that improve the disclosure will be outlined in greater detail below together with the description of preferred exemplary embodiments of the disclosure on the basis of the figures, in which is shown:

FIGS. 1a-1b a scenario according to a first exemplary embodiment of the disclosure for a swing door, in two views,

FIGS. 2a-2b a scenario according to a second exemplary embodiment of the disclosure for the swing door from FIG. 1, in two views,

FIG. 3 a scenario according to a third exemplary embodiment of the disclosure for the swing door from FIG. 1,

FIG. 4 a scenario according to a fourth exemplary embodiment of the disclosure for the swing door from FIG. 1,

FIGS. 5a-5d a scenario according to a fifth exemplary embodiment of the disclosure for a double-leaf sliding door, in four views,

FIG. 6 a scenario according to a sixth exemplary embodiment of the disclosure for a revolving door,

FIG. 7 a scenario according to a seventh exemplary embodiment of the disclosure for the revolving door from FIG. 6,

FIG. 8 a method for setting the detection region of a sensor device according to an exemplary embodiment of the disclosure,

FIG. 9 a method for setting the detection region of a sensor device according to another exemplary embodiment of the disclosure,

FIG. 10 a method for operating a door system, according to an exemplary embodiment of the disclosure, and

FIG. 11 the process of determining the door leaf movement speed of FIG. 10 in greater detail.

### DETAILED DESCRIPTION OF THE DRAWINGS

FIG. 1 shows a scenario according to a first exemplary embodiment of the disclosure for a door system 1, which is designed here as a single-leaf swing door 1, in two views. FIG. 1a shows the door system 1 in a plan view from above, i.e. in the direction of the floor, which is not represented. FIG. 1b shows the door system 1 in a side view from the right in Figure la with the door leaf 3 closed, thus parallel to the floor.

The door leaf 3 is pivotably hinged to a wall 2 of a building in a known manner, usually by means of a plurality of door hinges 10. A sensor device 4 is preferably attached to the door leaf 3 only on its side pointing in the opening direction (downward in FIG. 1a). The sensor device 4 has sensors of any known type and in any number. That is to say that the sensor device 4 is selected according to the respective use. A particular description of the design of the sensor device 4 is therefore omitted.

The door leaf 3′ represented with dashed lines is the same door leaf 3, only slightly open. In this respect, the reference numeral 4′ designates the same sensor device 4 in the closed position of the door leaf 3, just in a position in which the door leaf 3′ is open.

For reasons of clarity, the detection region 5′ of the sensor device 4′ is only represented in FIG. 1 a when the door leaf 3′ is open. The corresponding detection region 5 when the door leaf 3 is closed is indicated in FIG. 1b. In the scenario shown in FIGS. 1a and 1b, the door leaf 3 is opened at a first speed.

According to FIG. 1b, the sensor device 4 is pivotally attached at both ends to a respective holder 6, for example. The resulting two brackets 6 for the sensor device 4 are attached to the door leaf 3. The sensor device 4 can preferably be rotated in a motorized manner in the holders 6, such that the detection region 5 can be changed.

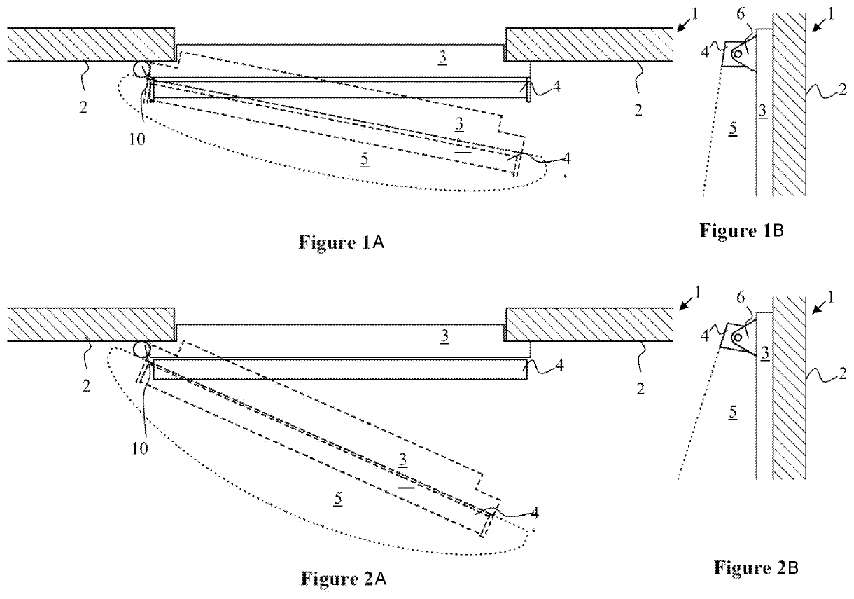

FIG. 2 shows a scenario according to a second exemplary embodiment of the disclosure for the door system 1 from FIG. 1, also in two views analogous to FIGS. 1a and 1b. In the scenario shown here, the door leaf 3 is opened at a higher speed than in FIG. 1a. If the same time has lapsed when opening the door leaf 3 from its closed position, the door leaf 3′ is opened further according to FIG. 2a compared to Figure la. In order to ensure that the door leaf 3′ continues to come to a safe standstill in front of any object detected by means of the sensor device 4′, the detection region 5, 5′ is changed such that its maximum distance from the door leaf 3, 3′ is greater than in the previous scenario. According to FIG. 2b, the sensor device 4 is rotated somewhat clockwise relative to FIG. 1b, such that the detection region 5 is wider than shown in FIG. 1b. The adjustment of the sensor device 4 can thereby take place continuously depending on the door leaf movement speed.

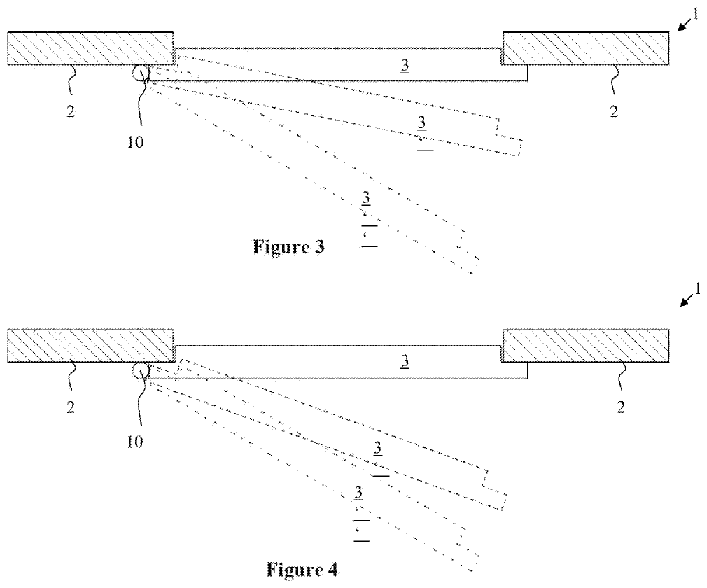

FIG. 3 shows a scenario according to a third exemplary embodiment of the disclosure for the same door system 1. The sensor device 4 is not represented here. Its detection region 5 is not adjusted here as an example. The door leaf 3 is in turn opened at an associated speed and has reached the position, in which the door leaf 3′ is shown in dashed lines, by the time an object is detected in the detection region of the sensor device. In order to prevent a collision, the door leaf 3′ is braked such that it reaches a position in which the door leaf 3″ is represented by a dashed line. If the obstacle is stationary, this position corresponds to a door leaf open position shortly before the object is reached. That is to say that the relative speed between the door leaf 3′ and the object corresponds to the current movement speed of the door leaf 3′. If the object moves towards the door leaf 3′, the relative speed is greater than the current movement speed of the door leaf 3′. In this case, the braking force of the door drive is increased such that the door leaf 3″ is opened less than represented in FIG. 3. If the object moves away from the door leaf 3′, the relative speed is less than the current movement speed of the door leaf 3′. In that case, the braking force of the door drive is reduced, such that the door leaf 3″ is opened further than represented in FIG. 3. If the relative speed is sufficiently low, a reduction in the door leaf movement speed is sufficient such that, in the most favorable case, the door leaf 3′ does not have to be stopped.

FIG. 4 shows a scenario according to a fourth exemplary embodiment of the disclosure for the same door system 1. The door leaf 3 is thereby opened at a higher speed than in FIG. 3. In order to continue to avoid a collision, the braking force of the door drive is increased.

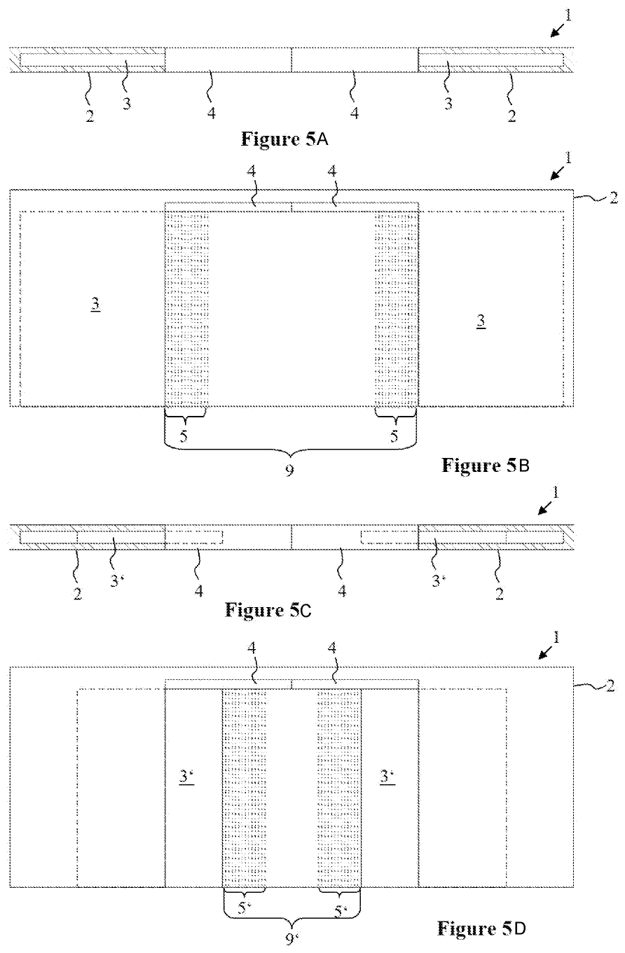

FIG. 5 shows a scenario according to a fifth exemplary embodiment of the disclosure for a door system 1 designed here as a double-leaf sliding door, in four views. FIG. 5a shows the door system 1 in the open position and in a view from above, i.e. in the direction of the floor, which is not represented. FIG. 5b shows the door system 1 in the same operating position in the passage direction, thus parallel to the floor. FIG. 5c shows the door system 1 in a partially open position in a view analogous to FIG. 5a, and FIG. 5d in the same operating position in a view analogous to FIG. 5b.

For each door leaf 3, 3, an associated sensor device 4 is attached preferably stationary to a wall 2 above. In FIGS. 5a and 5b, the passage region 9 of the door system 1 is at its maximum. In FIGS. 5c and 5d, the resulting passage region 9′ is smaller or narrower. In order that the door leaves 3, 3′ do not have to unnecessarily change their movement speed or are even stopped, each sensor device 4, 4 is preferably responsible for the travel region of the associated door leaf 3, 3′. If, for example, the left-hand sensor device 4 detects an object, this advantageously has no effect on the movement speed of the right-hand door leaf 3, 3′. Apart from that, each sensor device 4 comprises a plurality of sensors. The sensors are activated depending on the open position of the associated door leaf 3, 3′ such that the necessary detection region 5, 5′ is always ensured in front of its main closing edge of the associated door leaf 3, 3′. The detection regions 5, 5′ are, for example, of the same width as one another. Activation can thereby be done electronically.

It is of course also possible to design the sensor devices 4, 4 such that they also detect the secondary closing edge region of the associated door leaf 3, 3′. This is advantageous in the case of sliding doors which, seen in the passage direction, are moved in front of the wall 2 and not, as shown in FIGS. 5a-5d, into it. As a result, a risk of being trapped between door leaves 3, 3′ and the wall 2 is countered, for example.

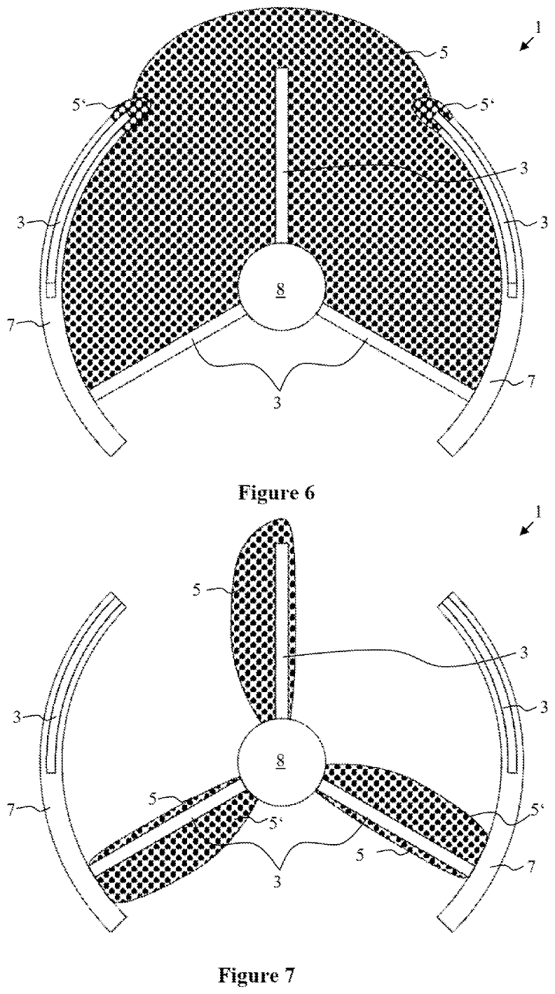

FIG. 6 shows a scenario according to an exemplary embodiment of the disclosure for a door system 1 designed as a revolving door. The door system 1 has, for example, a night shutter in the form of two arched sliding door leaves 3, 3′, which are retracted into an associated drum wall 7 when the door system 1 is in the open position. The turnstile 8 of the door system 1 is designed with three leaves, for example, i.e. it comprises three door leaves 3 attached stationarily.

If the night shutter is activated, it must be ensured that there is no object located in the movement region above the two lower door leaves 3, 3′ of the turnstile 8 or in the movement region of the sliding door leaves 3, 3′ and slightly outside of it in relation to the door system 1. Sensor devices 4, which are not shown in relation to the turnstile 8, are therefore designed such that they cover a detection region 5, which is filled with black dots here. In addition, the sliding door leaves 3, 3′ preferably have sensor devices 4, 4 which cover detection regions 5′, 5′ filled with white dots. If an object is detected in the entire detection region 5, 5′ formed in this way, the sliding door leaves 3, 3′ are preferably stopped completely until no more object is detected. This reliably prevents a person from becoming trapped, for example.

FIG. 7 shows a scenario according to another exemplary embodiment of the disclosure for the revolving door from FIG. 6. In the passage operation shown here, in which the sliding door leaves 3, 3 are fully open and the turnstile 8 is rotated counterclockwise, for example, the sensor devices 4, which are not represented, are preferably deactivated on the sliding door leaves 3, 3′. There is a separate detection region 5 for each turnstile door leaf 3, 3′, 3″. Each detection region 5 is designed such that it comprises a larger region in the direction of rotation in front of the respective turnstile door leaf 3, 3′, 3″ and preferably also a somewhat smaller region behind it. If the respective turnstile door leaf 3 is located outside of the drum walls 7, 7′, the respective detection region 5 also comprises a region around its free end (cf. upper door leaf 3). Otherwise, the detection region 5 ends at this free end (cf. the two lower door leaves 3, 3′). The “hiding” of the region around the respective free end can be done electronically by means of sensor deactivation. Alternatively, the inner sides of the drum walls 7, 7′ can be non-reflective, for example, such that the sensors cannot detect an object in the region of the free ends.

When the turnstile 8 rotates, objects are detected analogously to the scenarios according to FIGS. 1a to 4. Since the probability of detecting a plurality of objects at the same time is high, in particular with revolving doors, it is preferably provided to take into account the relative speeds of all objects detected in the detection regions 5, 5′, 5″ in relation to the respective associated turnstile door leaf 3, 3′, 3″. The rotational speed of the turnstile 8 is preferably adapted such that all objects that are located in the direction of rotation in front of one of the turnstile door leaves 3, 3′, 3″ have a relative speed to this respective door leaf 3, 3′, 3″ that is less than or equal to 0. Alternatively, the rotational speed can be set such that, assuming constant relative speeds, the objects will have left the revolving door when the respective door leaf 3 has reached the horizontal position of the respective object seen according to FIG. 7. In this context, the angular position of the respective turnstile door leaf 3, 3′, 3″ in relation to the vertical passage direction in FIG. 7 is also taken into account.

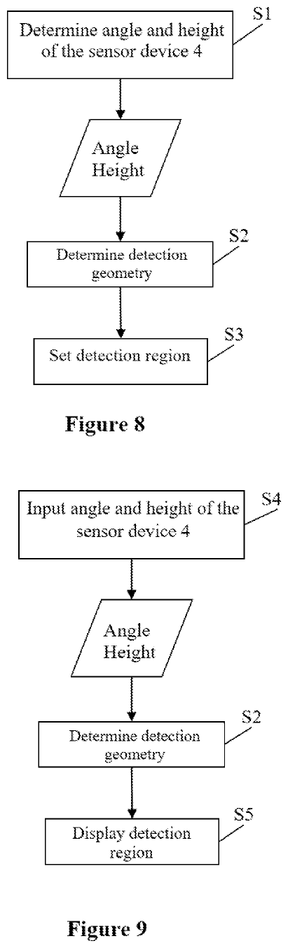

FIG. 8 shows a method for setting the detection region 5, 5′ of a sensor device 4, 4′ according to an exemplary embodiment of the disclosure. This method relates to sensor devices 4 according to FIG. 1. In a step S1, the current pivoting angle and the height of the respective sensor device 4 above the floor in relation to the door system 1 are determined. Based on this, the detection geometry is determined in a step S2, i.e. the dimensions of the associated detection region 5, 5′ in front of or around the respective door leaf 3, 3′. Based on this, in a subsequent step S3, if necessary, the detection region 5, 5′ is preferably set automatically if the determined detection geometry does not correspond to the movement speed of the door leaf 3, 3′. The door system 1 is thus adjusted by sensors in relation to this door leaf 3, 3′.

FIG. 9 shows an alternative method for setting the detection region 5, 5′ of the sensor device 4, 4′ according to another exemplary embodiment of the disclosure. Step S1 is thereby replaced by a step S4, according to which the values (here: pivoting angle and height) can be input. Step S3 is replaced by a step S5, according to which the detection region 5, 5′ of the respective sensor device 4, 4′ is displayed. That is to say that the sensor device 4, 4′ is not set automatically. This can be useful, for example, if the detection region 5, 5′ has to be selected to be larger than actually necessary for safety reasons. Influences such as wind loads that do not occur in a door system 1 located in a building can also be taken into account.

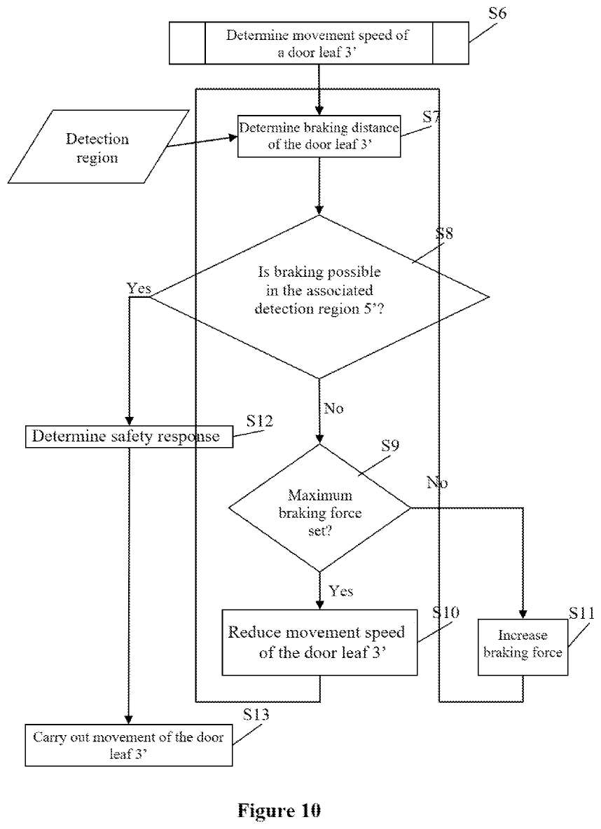

FIG. 10 shows a method for operating the door system 1 according to an exemplary embodiment of the disclosure, which is preferably carried out before each door leaf movement. In a step S6, a process of determining the movement speed of the relevant door leaf 3′ (that is, if it is moving) is determined. This can be done by input or a test run. In a subsequent step S7, the braking distance of the door leaf 3′ is determined on the basis of the previously determined detection region 5′. This can in turn be done by inputting, by reading an assignment table or by means of a test run. Then, in a step S8, it is checked whether braking in the detection region 5′ is definitely possible. If this is the case (Yes branch after step S8), the required safety response is determined in a subsequent step S12. This can in turn be done automatically, by input or by reading a data source. Stopping, reversing and slowing down the door leaf 3′ come into consideration as a safety response, for example. Then, in a subsequent step S13, the relevant door leaf 3′ is moved, i.e. a door leaf movement is carried out.

If braking in detection region 5′ is (definitely) not possible (No branch after step S8), it is checked in a subsequent step S9 whether the maximum door leaf braking force is set. If this is the case (Yes branch after step S9), the movement speed of the door leaf 5 is reduced. This can be done in preset stages. Thereafter, a jump is made back to step S7. Otherwise (No branch after step S9), the set braking force is also preferably increased in stages in a subsequent step S11. Thereafter, a jump is also made back to step S7.

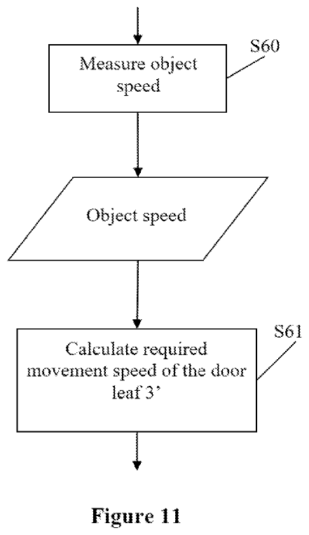

FIG. 11 shows the process of determining the door leaf movement speed from FIG. 10, i.e. step S6, in greater detail. In a first step S60, the speed of the respectively detected object is thereby measured. The speed is thereby preferably the above-mentioned relative speed of this object in relation to the relevant door leaf 3′. Based on this, the required movement speed of the relevant door leaf 3′ is calculated in a subsequent step S61 on the basis of the object speed determined in this way. After that, this process is ended.

The disclosure is not limited to the aforementioned exemplary embodiments. They can be interchanged or combined with one another in parts or in part as a whole.

If a door leaf 3′ is moved, step S4 can be extended such that the current movement speed of the door leaf 3′ is also included in the setting of the detection region 5′. In that case, the sensor device 4′ can also be automatically readjusted during the door leaf movement. This is advantageous because when the door leaf 3 is moved out of its rest position, the detection region 5 can be smaller than when the door leaf 3′ is moved. And if the door leaf 3′ is braked or even accelerated due to a safety response or, for example, due to a wind load, the respective detection region 5′ can be reduced or enlarged accordingly.

If the door system 1 comprises a plurality of door leaves 3 that are in particular motion-coupled to one another (e.g. door leaves of the turnstile 8, a double-leaf sliding door with belt drive, a double-leaf swing door with active and fixed leaf), sensor signals from the sensor devices 4, 4′ of the door leaves can be processed together, for example with a logical OR link. Particularly in the scenario shown in FIG. 5a, it makes sense to couple the sensor devices of the sliding door leaves 3 to the sensor devices for the turnstile door leaf 3 accordingly.

The door system 1 can be of any type, for example a double-leaf swing door with active and fixed leaf, a single-leaf sliding door, a folding door, a revolving door with a two-leaf or more than three-leaf turnstile with and without additional night shutter, a one- or two-leaf telescopic sliding door, door systems combined with one another such as an interlock system with two individual door systems located one behind the other, for example in the form of sliding doors.

In all of the aforementioned embodiments, the case can arise that a plurality of objects are detected simultaneously, possibly at different relative speeds to one or a plurality of door leaves. In this case, the movement speed of the door leaf(s) is calculated such that the following applies: resulting relative speeds ≤0. If this is not possible because, for example, two objects are approaching a door leaf from both sides, two safety responses can be provided. The first would be an immediate stop of the door leaf. The second safety response would be to brake the door leaf to a speed at which the relative speeds of both objects are the same or are such that, assuming constant relative speeds, the door leaves cannot collide with any of the objects because some objects have left the movement region of the door leaf or leaves. This shows the advantage of continuous monitoring of the relative speeds: If one of the objects stops or even moves away from the door leaf, the door leaf can optionally be brought to a speed at which all relative speeds are all equal to or less than 0.

When adjusting the braking force, an adjustment process can be provided in which, if necessary, the braking force is first gradually adjusted to the maximum. When the maximum braking force is reached, the detection region of the sensor device(s) 4, 4′ is increased, which allows the braking force to be reduced. The adjustment process is then (re)started again.

The sensor devices 4 from FIG. 1 can be replaced by the sensor devices 4 according to FIG. 5 or can be combined with one another.

As a result, the disclosure creates a solution for a safe and yet fail-safe door system. In particular, downtimes of door systems can be reduced. The design of the disclosure is not restricted to the preferred exemplary embodiment indicated above. In fact, a number of variants is conceivable which make use of the represented solution even in the case of fundamentally different designs. All features and/or advantages emerging from the claims, the description or the drawings, including constructive details or spatial arrangements, may be essential to the disclosure even in the most varied combinations.

1. A safety device for an automated door system, the safety device comprising:
a sensor device, designed to be arranged on the door system such that an associated detection region of the sensor device covers a danger region of an associated door leaf using sensors, and configured to detect the presence of an object within the associated detection region, and
a control device, wherein the control device is configured
to change the associated detection region on the basis of a current movement speed of the associated door leaf and/or
to determine a detection geometry and to actuate a door drive of the associated door leaf such that a predetermined movement speed of the associated door leaf is provided depending on the determined detection geometry and/or a braking force and/or a braking distance of the associated door leaf is or are adapted to the current movement speed of the associated door leaf.

2. The safety device according to claim 1, wherein
the changing of the detection region of the sensor device is implemented in that the sensor device has an adjustment device which is coupled to the control device such that the control device is able to adjust the sensor device such that its detection region changes.

3. The safety device according to claim 1,
wherein
the detection geometry is determined by a height and an angle of the sensor device.

4. The safety device according to claim 1,
wherein
the control device is configured to determine the detection geometry such that the braking force and/or the braking distance of the associated door leaf is or are adapted to the current movement speed of the associated door leaf in the event of a safety response.

5. A use of a safety device according to claim 1 in a door drive with at least one drive unit for moving the at least one associated door leaf or in a door system with the at least one associated door leaf.

6. An automated door system comprising:
at least one door leaf and
for the at least one door leaf, a door drive movement-operatively connected to the at least one door leaf,
wherein
a safety device according to claim 1, wherein the at least one door leaf is the associated door leaf.

7. The door system according to claim 6,
wherein a door leaf is designed as a sliding door leaf and the danger region of the sliding door leaf during its closing movement comprises a region of a travel path of the sliding door leaf, seen in the closing direction of the sliding door leaf, directly in front of a main closing edge of the sliding door leaf .

8. The door system according to claim 7,
wherein the danger region of the sliding door leaf also comprises
during its opening movement, a region of a travel path of the sliding door leaf, seen in the movement direction of the sliding door leaf, directly in front of a secondary closing edge of the sliding door leaf and/or
a region laterally adjoining the sliding door leaf.

9. The door system according to claim 6
wherein a door leaf is designed as a swing door leaf and the danger region of the swing door leaf is a predetermined part of a region which the swing door leaf covers during its opening and closing movement and which is located in front of the swing door leaf in the movement direction of the swing door leaf.

10. The door system according to claim 6
wherein the door system is designed as a revolving door with a turnstile, a door leaf is attached to the turnstile and the danger region of the door leaf is a predetermined part of a circular area which the door leaf covers due to the rotation of the turnstile and is located in the direction of rotation of the turnstile in front of the door leaf.

11. A method for operating a door system according to claim 6, the method including the following steps:
monitoring the danger region of the associated door leaf by the sensor device and
characterized byfurther including:
adapting the detection region of the associated door leaf on the basis of a current movement speed of the associated door leaf and/or,
determining a detection geometry and actuating a door drive of the associated door leaf such that a predetermined movement speed of the associated door leaf is provided depending on the determined detection geometry and/or a braking force and/or a braking distance of the associated door leaf is or are adapted to the current movement speed of the associated door leaf.

12. The method according to claim 11, further including the following step:
actuating, in the event of a safety response, the drive of the associated door leaf such that it is ensured that the associated door leaf reaches the maximum position of a possible object in the detection region of the sensor device when it is first detected and/or taking into account its relative speed to the door leaf or, in its current movement direction, comes to a standstill in front of this position.

13. The method according to claim 12,
whereby the safety response comprises:
stopping the associated door leaf, if the recorded relative speed between the detected object and the associated door leaf corresponds to the movement speed of the associated door leaf at the time the respective object is first detected or an object is also detected on a side of the associated door leaf facing away from the detected object,
reversing the associated door leaf, in particular if the recorded relative speed between the detected object and the associated door leaf is higher than the movement speed of the associated door leaf at the time the respective object is first detected and no object is detected on the side of the associated door leaf facing away from the detected object, and/or
slowing down the associated door leaf, in particular if the recorded relative speed between the detected object and the associated door leaf is greater than 0 and lower than the movement speed of the associated door leaf at the time the respective object is first detected and/or an object is also detected on the side of the associated door leaf facing away from the detected object.

14. The method according to claim 11,
further including the step of
actuating the respective drive, in normal operation, depending on a sensor-determined entry speed in relation to the associated door leaf.

15. The method according to claim 14,
wherein
the entry speed is the movement speed of the object moving fastest towards the passage region of the door system or through the passage region or the greatest relative speed to the respective door leaf.
